(19) United States
(12) Patent Application Publication
(10) Pub. No.: US 2026/0245442 A1
(43) Pub. Date: Aug. 20, 2026

(54) NOTIFICATION DEVICE, NOTIFICATION SYSTEM, NOTIFICATION METHOD, AND RECORDING MEDIUM

(71) Applicants: NEC Corporation, Tokyo (JP); NEC Platforms, Ltd., Kanagawa (JP)

(72) Inventors: Ryo HACHIYA, Tokyo (JP); Teisuya MIHIRA, Kanagawa (JP); Hiroyuki KAWAMOTO, Kanagawa (JP); Daichi SHIMOHATA, Kanagawa (JP); Wakana INOUE, Kanagawa (JP)

(73) Assignees: NEC Corporation, Tokyo (JP); NEC Platforms, Ltd., Kanagawa (JP)

(21) Appl. No.: 19/162,429

(22) PCT Filed: Mar. 23, 2023
(86) PCT No.: PCT/JP2023/011415

§ 371 Date: Sep. 5, 2025

(51) Int. Cl. G08B 13/24

(52) U.S. Cl. CPC G08B 13/2434; G08B 13/2417

(57) ABSTRACT

A notification device includes, at least one memory storing instructions, and at least one processor configured to execute the instructions to, acquire a read information when a reading device reads first product identification information on a product, the first product identification information being stored in a price label tag that is detachable and attached to the product held by a customer, and second product identification information on the product, the second product identification information being stored in a spare tag that is not detachable from the product, determine whether the first product identification information is readable based on the read information, and notify determination when the first product identification information is determined to fail to be read.

### TECHNICAL FIELD

The present disclosure relates to a notification device and the like.

### BACKGROUND ART

There is a technique of using a radio frequency identification (RFID) tag as a price label tag of clothing items such as clothes and hats. However, there is a problem of shoplifting for apparel, in which a customer removes a price label tag from a product in a store and takes out the product.

There is a technique for preventing shoplifting as described above. For example, PTL 1 discloses a notification or an alarm that is performed when an identification tag, an electronic article surveillance tag, and/or an electronic price label, which are attached to a product and are remotely readable, are different in number between when a customer is in a fitting area and when the customer leaves the fitting area.

### CITATION LIST

### Patent Literature

PTL 1: JP 2018-502361 A

### SUMMARY OF INVENTION

### Technical Problem

Unfortunately, the technique described in PTL 1 fails to detect a product that may be shoplifted when all of the identification tag, the electronic article surveillance tag, and/or the electronic price label are removed.

It is an object of the present disclosure to provide a notification device or the like capable of improving detection accuracy of a product that may be shoplifted.

### Solution to Problem

A notification device according to an aspect of the present disclosure includes acquisition means for acquiring read information when a reading device reads first product identification information on a product, the first product identification information being stored in a price label tag that is detachable and attached to the product held by a customer, and second product identification information on the product, the second product identification information being stored in a spare tag that is not detachable from the product, determination means for determining whether the first product identification information is readable based on the read information, and output control means for notifying determination when the first product identification information is determined to fail to be read.

A notification method according to an aspect of the present disclosure includes, by a computer, acquiring read information when a reading device reads first product identification information on a product, the first product identification information being stored in a price label tag that is detachable and attached to the product held by a customer, and second product identification information on the product, the second product identification information being stored in a spare tag that is not detachable from the product, determining whether the first product identification information is readable based on the read information, and notifying determination when the first product identification information is determined to fail to be read.

A program according to an aspect of the present disclosure causes a computer to perform the steps of acquiring read information when a reading device reads first product identification information on a product, the first product identification information being stored in a price label tag that is detachable and attached to the product held by a customer, and second product identification information on the product, the second product identification information being stored in a spare tag that is not detachable from the product, determining whether the first product identification information is readable based on the read information, and notifying determination when the first product identification information is determined to fail to be read.

The program may be stored in a non-transitory computer-readable recording medium.

### Advantageous Effects of Invention

The present disclosure enables improvement in detection accuracy of a product that may be shoplifted.

### BRIEF DESCRIPTION OF DRAWINGS

FIG. 1 is a block diagram illustrating an example of a configuration including a notification device according to a first example embodiment.

FIG. 2 is a schematic diagram for illustrating an example of a reading device according to the first example embodiment.

FIG. 3 illustrates an example of a product to which a price label tag and a spare tag are attached in the first example embodiment.

FIG. 4 is a diagram for illustrating positions of reading devices installed in a store in the first example embodiment.

FIG. 5 is a diagram illustrating an example of a hardware configuration in which the notification device according to the first example embodiment is implemented by a computer device including a processor.

FIG. 6 illustrates an example of a screen for notification performed by an output control unit according to the first example embodiment.

FIG. 7 is a flowchart illustrating operation of notification according to the first example embodiment.

FIG. 8 is a flowchart illustrating operation of notification according to a modification of the first example embodiment.

FIG. 9 is a block diagram illustrating an example of a configuration including a notification device according to a second example embodiment.

FIG. 10 is an example of output to a terminal device of a store clerk according to the second example embodiment.

FIG. 11 is a flowchart illustrating operation of notification according to the second example embodiment.

FIG. 12 is a block diagram illustrating an example of a configuration including a notification device according to a third example embodiment.

FIG. 13 is an example of output to a terminal device of a store clerk according to the third example embodiment.

FIG. 14 is a flowchart illustrating operation of notification according to the third example embodiment.

### EXAMPLE EMBODIMENT

### First Example Embodiment

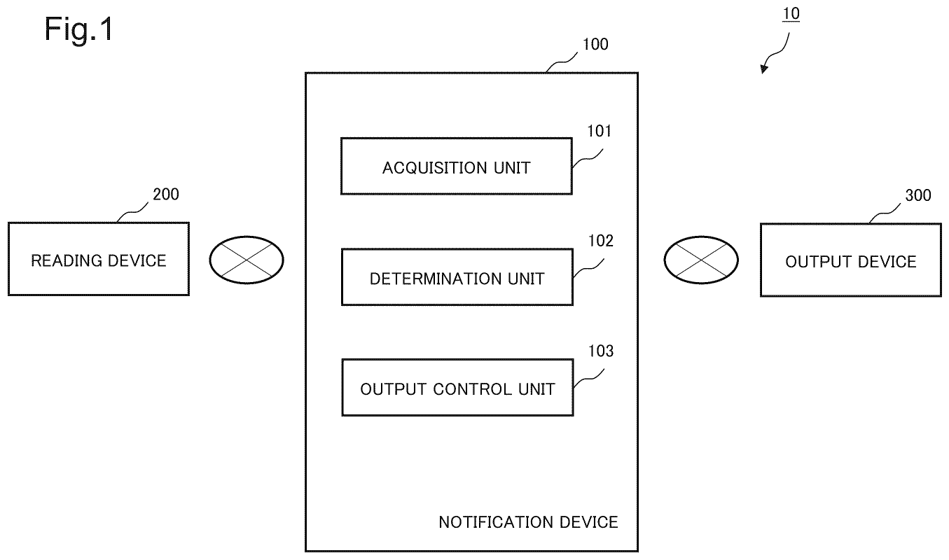

First, a first example embodiment of the present disclosure will be described in detail with reference to the drawings. FIG. 1 is a block diagram illustrating an example of a configuration including a notification device 100 according to the first example embodiment. As illustrated in FIG. 1, a notification system 10 includes the notification device 100 that is connected to a reading device 200 and an output device 300 through a network.

The notification device 100 notifies that a price label tag has been removed from a product held by a customer shopping in a store. The reading device 200 is installed in a place where a customer passes through and reads product identification information stored in an RFID tag attached to a product held by the customer. The output device 300 notifies a store clerk or the like when detecting a product from which the price label tag has been removed, and is a terminal device of the store clerk such as a display installed in a backyard of the store or a terminal carried by the store clerk, for example. The store is a retail store that sells clothes, foods, or the like, for example.

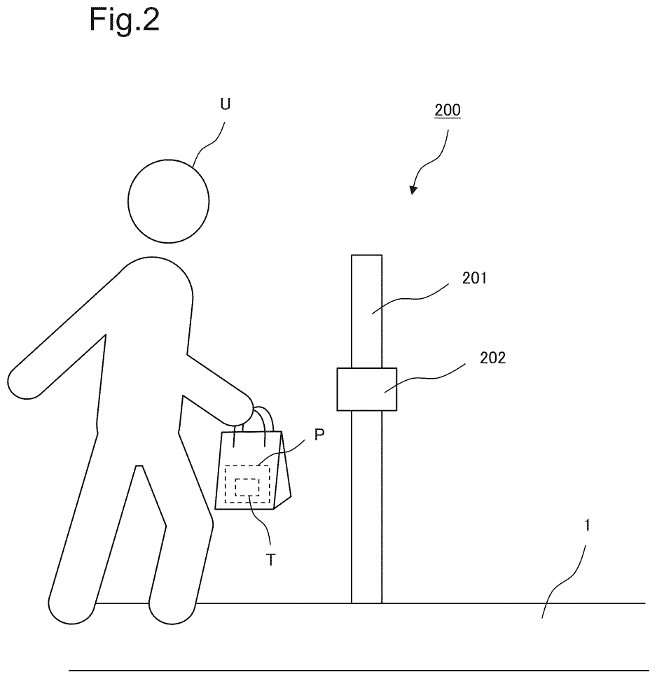

FIG. 2 is a schematic diagram for illustrating an example of the reading device 200 according to the first example embodiment. FIG. 2 illustrates the example in which the reading device 200 is provided beside a passage 1 through which a customer U passes. Although FIG. 2 illustrates the example in which the reading device 200 is provided on one side of the passage 1, the reading device 200 may be provided on each side of the passage 1. The reading device 200 includes an RFID reader 201 and an antenna 202. The antenna 202 transmits a radio wave toward an RFID tag T attached to a product P or the like held by the customer U passing through the passage 1, and the RFID reader 201 reads the product identification information transmitted on the radio wave received from the RFID tag T according to a predetermined communication protocol. The antenna 202 reads the product identification information from the RFID tag T while the customer U walks on the passage 1.

In the present example embodiment, a price label tag including a first RFID that stores product identification information on a product and a spare tag including a second RFID are attached to a product sold in a store.

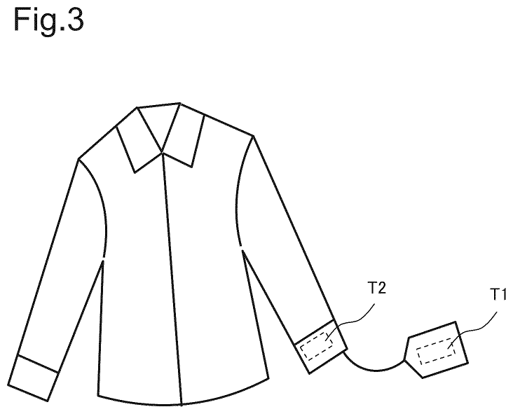

FIG. 3 illustrates an example of a product to which a price label tag T1 and a spare tag T2 are attached. The price label tag T1 is detachable from the product, and is attached to the product using a string, for example. The spare tag T2 is less likely to be removed without damaging clothes, and examples of the spare tag T2 include a laundry tag and a clothes tag. The spare tag T2 is attached to clothes by various methods such as iron bonding, using an adhesive for clothes, and sewing. The spare tag T2 may be a button type tag made of resin or a tag made of fiber, for example. As illustrated in FIG. 3, the spare tag T2 may be attached to a collar or a folded-back part of a cuff that cannot be visually recognized from the outside, for example.

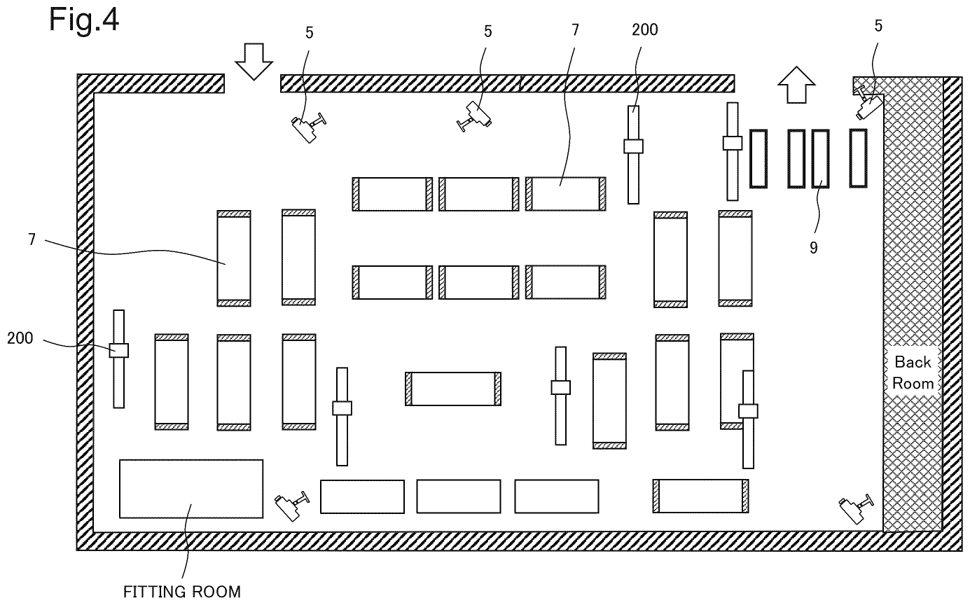

Reading devices 200 are installed at different positions in a store. The reading devices 200 may be installed on a ceiling, a wall, a mirror, a gate, or the like, in addition to the sides of the passage, for example. The reading device 200 may be installed at a place where a customer always passes after entering the store. Examples of the place where a customer always passes include a place where point of sale (POS) is installed and a place where settlement processing by cashless payment is performed. FIG. 4 is a diagram for illustrating positions of the reading devices 200 installed in a store in the first example embodiment. As illustrated in FIG. 4, the store may be provided with an imaging device 5 such as a camera that tracks behavior of a customer in the store, for example. The imaging device 5 may track a customer who visits the store from an entrance. The store is provided with at least one display shelf 7. Products are displayed on the display shelf 7. The customer in the store takes out a product to be purchased from the display shelf 7, puts the product in a bag or a cart, and heads to a gate device 9 at an exit.

The customer holding the product that has not been subjected to settlement processing goes to the gate device 9 to pass through the gate device 9, and then can go out of the store. The product identification information may be read from the RFID tag T of the product while the product passes through the gate device 9, and the settlement processing of the read product may be performed in accordance with settlement information registered in advance.

The reading device 200 may be further set in a passage continued from a deep place such as a place near a fitting room in the store, for example. The price label tag T1 may be removed at such a place behind the fitting room. FIG. 4 illustrates an example in which a plurality of reading devices 200 is installed near the fitting room.

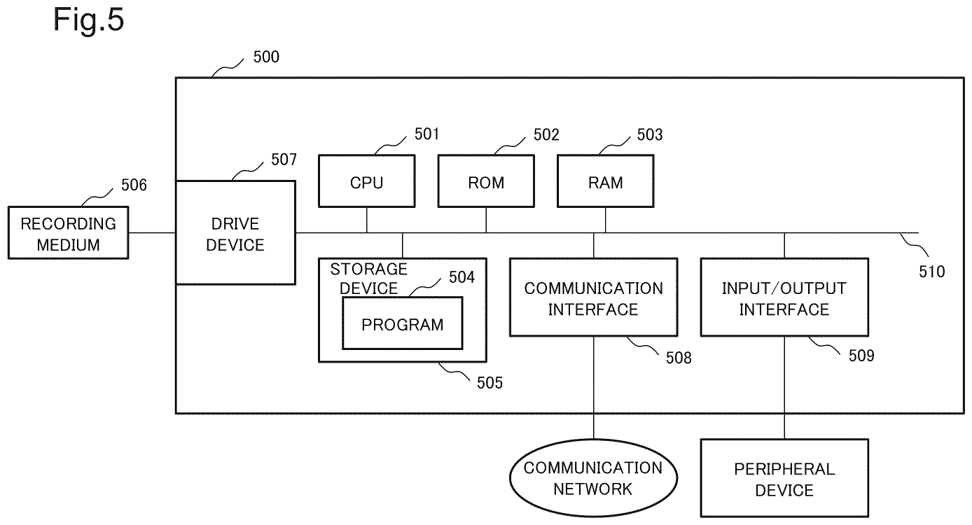

Returning to FIG. 1, the notification device 100 includes an acquisition unit 101, a determination unit 102, and an output control unit 103. FIG. 5 is a diagram illustrating an example of a hardware configuration in which the notification device 100 according to the first example embodiment of the present disclosure is implemented by a computer device 500 including a processor. As illustrated in FIG. 5, the notification device 100 includes a central processing unit (CPU) 501, memories such as a read only memory (ROM) 502 and a random access memory (RAM) 503, a storage device 505 such as a hard disk that stores a program 504, a communication interface 508 for network connection, and an input/output interface 509 that inputs and outputs data. In the first example embodiment, the notification device 100 is connected to each component using a bus 510. The notification device 100 according to the first example embodiment illustrated in FIG. 1 may be implemented by cloud computing or the like.

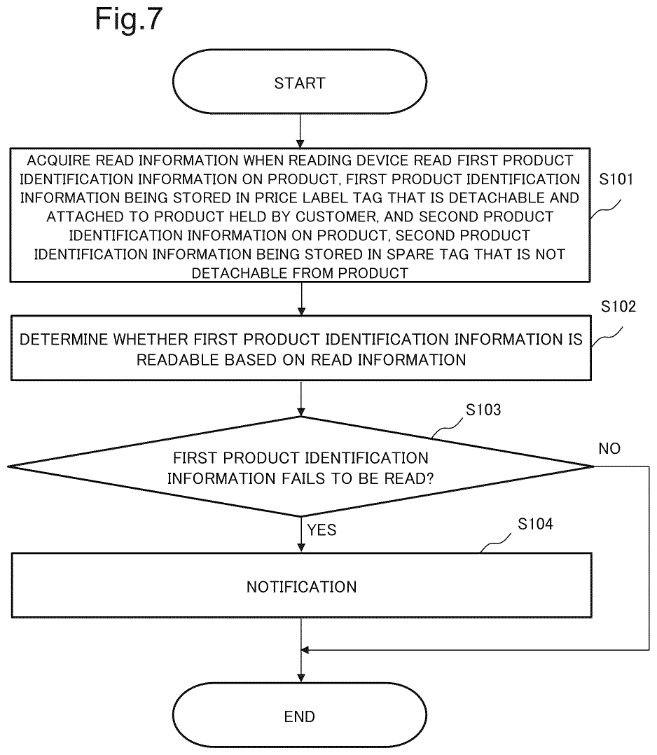

The CPU 501 controls the whole of the notification device 100 according to the first example embodiment of the present invention by operating an operating system. The CPU 501 reads a program and data onto a memory from a recording medium 506 attached to a drive device 507, for example. The CPU 501 also functions as the acquisition unit 101, the determination unit 102, the output control unit 103, and a part thereof in the first example embodiment, and performs processing or a command in the flowchart illustrated in FIG. 7 to be described later based on a program.

The recording medium 506 is an optical disk, a flexible disk, a magnetic optical disk, an external hard disk, or a semiconductor memory or the like, for example. The semiconductor memory or the like is a part of the recording medium and is a non-volatile storage device, and a program is recorded in the non-volatile storage device. The program may be downloaded from an external computer (not illustrated) connected to a communication network.

As described above, the first example embodiment illustrated in FIG. 1 is implemented by the computer hardware illustrated in FIG. 5. However, means for implementing each unit provided in the notification device 100 in FIG. 1 is not limited to the configuration described above. The notification device 100 may be implemented by one physically coupled device, or may be implemented by a system including a plurality of devices in which two or more physically separated devices are connected in a wired or wireless manner.

The acquisition unit 101 acquires read information when the reading device reads first product identification information on a product, the first product identification information being stored in a price label tag that is detachable and attached to the product held by a customer, and second product identification information on the product, the second product identification information being stored in a spare tag that is not detachable from the product. The price label tag includes the first RFID and the spare tag includes the second RFID in the present example embodiment. Specifically, the acquisition unit 101 acquires the read information including received signal strength from the first RFID and the second RFID, or the number of times of reading the first product identification information and the second product identification information per unit time. The received signal strength herein is a value of a received signal strength indicator (RSSI) received by the antenna 202 of a reading device 220. The acquisition unit 101 outputs the acquired read information to the determination unit 102.

The determination unit 102 determines whether the first product identification information is readable based on the read information. When the price label tag is removed from the product, the reading device 200 receives a signal with weak received signal strength from the first RFID, and a signal with strong received signal strength from the second RFID, in the present example embodiment. Thus, the determination unit 102 determines that the first product identification information fails to be read when the received signal strength from the first RFID is smaller than a preset threshold, or when the received signal strength from the first RFID is smaller than the received signal strength from the second RFID by a predetermined value or more. The determination unit 102 also may determine whether reading can be performed based on the number of times of reading the first product identification information. That is, the determination unit 102 determines that the first product identification information fails to be read when the number of times of reading the first product identification information is smaller than a preset threshold or when the number of times of reading the first product identification information is smaller than the number of times of reading the second product identification information by a predetermined number of times or more. When determining that the first product identification information fails to be read, the determination unit 102 outputs information on the determination to the output control unit 103.

When the first product identification information is determined to fail to be read, the output control unit 103 issues a notification. The output device 300 used for the notification is not particularly limited to a terminal device, a lighting device, a voice output device, or the like.

The output control unit 103 may output the notification to a terminal device installed in the store. Consequently, at least one of the store clerk and the customer is notified. For example, the terminal device installed in the store may be located near the reading device 200 that has read the product identification information. When notifying a voice output device provided in the gate device 9 near the exit, for example, the output control unit 103 may cause the voice output device to output a beep sound. Alternatively, the output control unit 103 may cause the output device 300 to output a voice such as “Are there any unpaid products?”, for example.

The output control unit 103 may output the notification to the terminal device of the store clerk. This allows the store clerk to be notified immediately. More specifically, when a position of the store clerk can be detected, the output control unit 103 outputs a notification to the terminal device of the store clerk based on the position of the reading device 200 and the position of the store clerk, for example. The output control unit 103 outputs a message or the like instructing the store clerk to go to the reading device 200. The message includes identification information (e.g., information indicating the location of the reading device 200) of the reading device 200. The position of the terminal device of the store clerk may be used as the position of the store clerk.

As a method for detecting the position of the store clerk, an existing technique such as position detection with a beacon or an RFID tag using the terminal device of the store clerk, position detection from an image captured by the imaging device 5, or the like may be used.

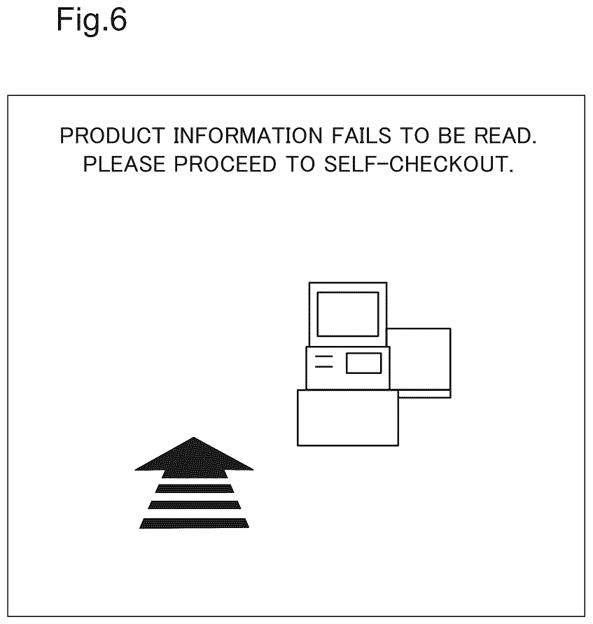

Next, a notification example when the reading device 200 is provided in the gate device 9 near the exit of the store will be described. FIG. 6 illustrates an example of a screen for notification performed by the output control unit 103 according to the first example embodiment. As illustrated in FIG. 6, when the determination unit 102 determines that the first product identification information fails to be read, the output control unit 103 outputs guidance information for guiding to another place for reading the first product identification information. Examples of the other place for the reading include a self-point of sale (POS), a semi-self-POS, and a loading table for bagging a product. Consequently, when the reading device 200 provided in the gate device 9 fails to read the information, the customer can be guided to correctly read again.

Besides the above, when a terminal device of a customer can be identified by a beacon installed in the store and an RFID tag mounted on the terminal device of the customer in the store, the output control unit 103 may notify the terminal device of the customer, for example. This notification is based on that an application program capable of performing notification is installed in the terminal device of the customer, and a store visit acceptance processing such as check-in to the store is performed.

The output control unit 103 notifies the terminal device of the customer located closest to the reading device 200, for example. This notification enables the customer to recognize that the price label tag of the product held by the customer is removed.

### (Flowchart)

FIG. 7 is a flowchart illustrating an outline of operation of the notification device 100 according to the first example embodiment. Processing according to this flowchart may be performed based on program control performed by the processor described above.

As illustrated in FIG. 7, the acquisition unit 101 acquires read information on the first product identification information on the product, the first product identification information being stored in the price label tag that is detachable and attached to the product held by the customer, and the second product identification information on the product, the second product identification information being stored in the spare tag that is not detachable from the product (step S101). Next, the determination unit 102 determines whether the first product identification information is readable based on the read information (step S102). When the determination unit 102 determines that the first product identification information fails to be read (step S103: YES), the output control unit 103 issues a notification (step S104). In contrast, when the determination unit 102 determines that the first product identification information has been read (step S103: NO), the notification device 100 ends operation of the notification.

When a customer shoplifts a product, the customer may remove a price label tag from the product in the store and take out the product. That is, some customers think that shoplifting of a product from which a price label tag is removed will not be revealed to the store clerk.

Against the shoplifting, the notification device 100 acquires read information when the reading device reads the first product identification information on the product, the first product identification information being stored in the price label tag that is detachable and attached to the product held by the customer, and the second product identification information on the product, the second product identification information being stored in the spare tag that is not detachable from the product. Then, when the determination unit 102 determines that the first product identification information on the product stored in the price label tag attached to the product fails to be read, the output control unit 103 issues a notification. Consequently, the second product identification information in the spare tag that is not detachable from the product is readable even when the price label tag is removed from the product, so that the product that may be shoplifted can be detected. Thus, detection accuracy of a product that may be shoplifted can be improved.

### First Modification of First Example Embodiment

Next, each modification of the first example embodiment will be described. Each modification can be combined with each other. For example, an output control unit 103 according to a first modification may output product information in which it is determined that the first product identification information fails to be read, or may turn on lighting means provided in the product, for making the notification.

When the determination unit 102 determines that the first product identification information fails to be read in the present modification, the determination is notified only when the first product identification information has been read before a predetermined time instead of notifying the determination immediately. The present modification is based on an assumption that a plurality of reading devices 200 is provided in the store, and any of the reading devices 200 can read product identification information in each of the price label tag and the spare tag of each product displayed on a display shelf 7.

When determining that the first product identification information fails to be read in the present modification, the determination unit 102 outputs information on the determination to an acquisition unit 101. Next, the acquisition unit 101 acquires read information when the first product identification information in the first RFID and the second product identification information in the second RFID of one product are read by any reading device 200 in the store before the predetermined time, and outputs the read information to the determination unit 102. Before the predetermined time may be any time as long as it is before the customer takes out the product from the display shelf 7, for example, before the customer visits the store. The determination unit 102 determines whether the first product identification information has been read before the predetermined time based on the read information received. A method for determining whether reading can be performed by the determination unit 102 is similar to that in the first example embodiment. The determination unit 102 outputs a result of the determination to the output control unit 103. The output control unit 103 issues a notification when receiving the result of the determination that the first product identification information has been read before the predetermined time from the determination unit 102.

### (Flowchart)

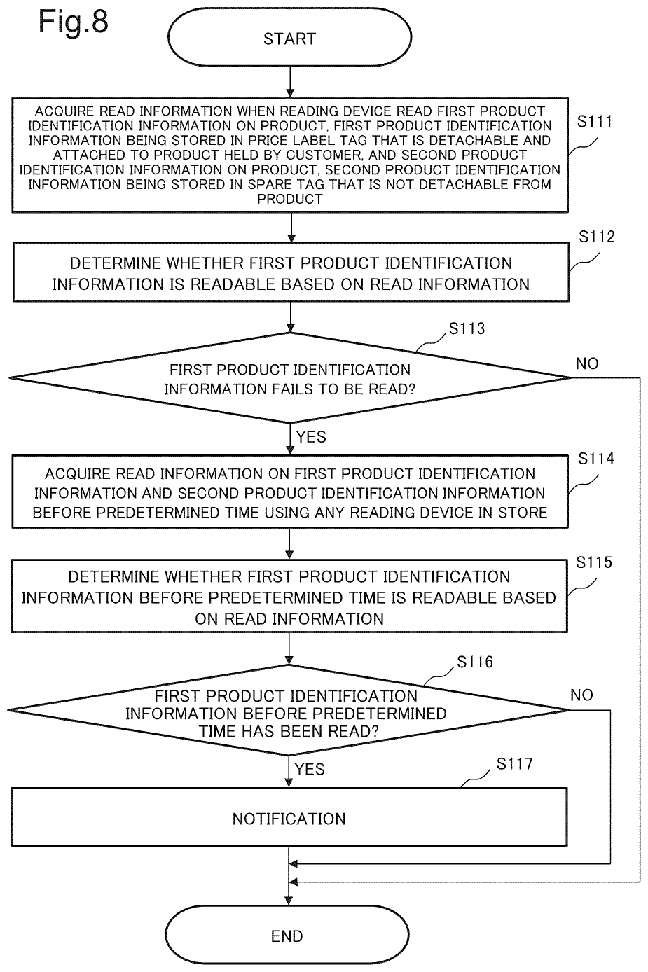

FIG. 8 is a flowchart illustrating an outline of operation of a notification device 100 according to a modification of the first example embodiment. Processing according to this flowchart may be performed based on program control performed by the processor described above.

As illustrated in FIG. 8, the acquisition unit 101 first acquires read information on the first product identification information on the product, the first product identification information being stored in the price label tag that is detachable and attached to the product held by the customer, and the second product identification information on the product, the second product identification information being stored in the spare tag that is not detachable from the product (step S111). Next, the determination unit 102 determines whether the first product identification information is readable based on the read information (step S112).

When the determination unit 102 determines that the first product identification information fails to be read (S113; YES), the acquisition unit 101 acquires the read information on the first product identification information and the second product identification information before the predetermined time using any reading device 200 in the store (step S114). In contrast, when the determination unit 102 determines that the first product identification information has been read (S113; NO), the notification device 100 ends the flow.

Next, the determination unit 102 determines whether the first product identification information has been read before the predetermined time based on the read information (step S115). When the determination unit 102 determines that the first product identification information has been read before the predetermined time (S116; YES), the output control unit 103 issues a notification (step S117). In contrast, when the determination unit 102 determines that the first product identification information has failed to be read before the predetermined time (S116; NO), the notification device 100 ends the flow.

The price label tag is detachable, so that the price label tag may be already removed before the customer takes out the product from the display shelf 7. For the removal of the price label tag, the notification device 100 in the present modification determines whether the first product identification information has been read before the predetermined time by any reading device 200 installed in the store when the determination unit 102 determines that the first product identification information fails to be read. Then, the output control unit 103 issues a notification only when the first product identification information has been read before the predetermined time. Consequently, the notification can be issued only when the price label tag may be removed by the customer while issuing no notification when the price label tag has been removed before the predetermined time.

### Second Modification of First Example Embodiment

When the first product identification information is determined to fail to be read in the present modification, not only a notification is issued, but also product information is output in which the first product identification information is determined to fail to be read. The present modification allows a storage device 505 to store the first product identification information, the second product identification information, and the product information in association with each other. The product information includes a name of a product, a price of the product, an image of the product, and a size of the product, for example. When a determination unit 102 determines that the first product identification information fails to be read in the present modification, an acquisition unit 101 acquires the second product identification information read by a reading device 200. Next, an output control unit 103 outputs the product information associated with the second product identification information. Consequently, a product that may be shoplifted can be identified. When notifying the terminal device of the customer, the output control unit 103 may output the product information in which the first product identification information is determined to fail to be read on an application program. This configuration enables the customer to check a product from which a price label tag is removed.

### Third Modification of First Example Embodiment

When the first product identification information is determined to fail to be read in the present modification, not only a notification is issued, but also lighting means provided in the product is turned on. The present modification is based on an assumption that the second RFID is provided with the lighting means such as an LED. When a determination unit 102 determines that the first product identification information fails to be read, an output control unit 103 transmits a radio wave from an antenna 202 to the second RFID. Consequently, power is supplied to the second RFID, and the LED is turned on. Thus, a product that may be shoplifted can be recognized.

### Second Example Embodiment

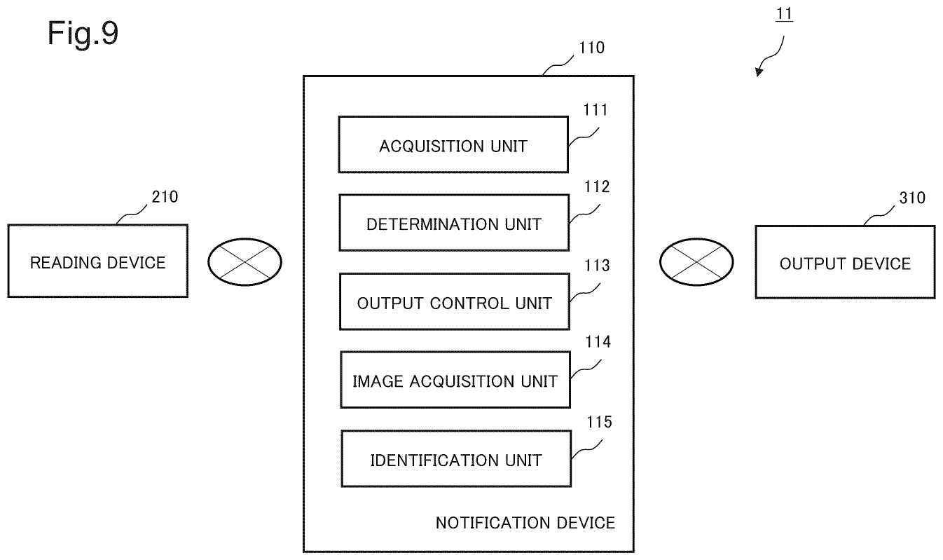

Next, a second example embodiment of the present disclosure will be described in detail with reference to the drawings. FIG. 9 is a block diagram including a notification device 110 according to the second example embodiment. A notification system 11 according to the present example embodiment includes the notification device 110 that is connected to a reading device 210 and an output device 310 through a network.

Hereinafter, duplicated contents with the above description will not be described to the extent that the description of the present example embodiment is not unclear. As in the computer device illustrated in FIG. 5, the function of each component in each example embodiment of the present disclosure can be achieved not only by hardware but also by a computer device or software based on program control.

With reference to FIG. 9, the notification device 110 includes an acquisition unit 111, a determination unit 112, an output control unit 113, an image acquisition unit 114, and an identification unit 115. The acquisition unit 111 and the determination unit 112 are similar to associated configurations of the first example embodiment, and thus will not be described.

When the first product identification information is determined to fail to be read, the image acquisition unit 114 acquires an image captured near the reading device 210 by an imaging device installed in the store. Specifically, the image acquisition unit 114 acquires an image captured near the reading device 210 by the imaging device such as a security camera installed in the store, for example. Examples of the image acquired here include a moving image including a period of a predetermined time before and after the reading device 210 reads the second product identification information on a target product.

The identification unit 115 identifies a product or a customer holding the product that is determined to fail to read the first product identification information on the image captured. The identification unit 115 identifies a product or a customer on the image, the product or the customer being closest to the reading device 210 when the second product identification information is read. The identification unit 115 may acquire a feature value of the product or the customer using a known method to identify the product or the customer having the same feature value on the image being captured by the security camera.

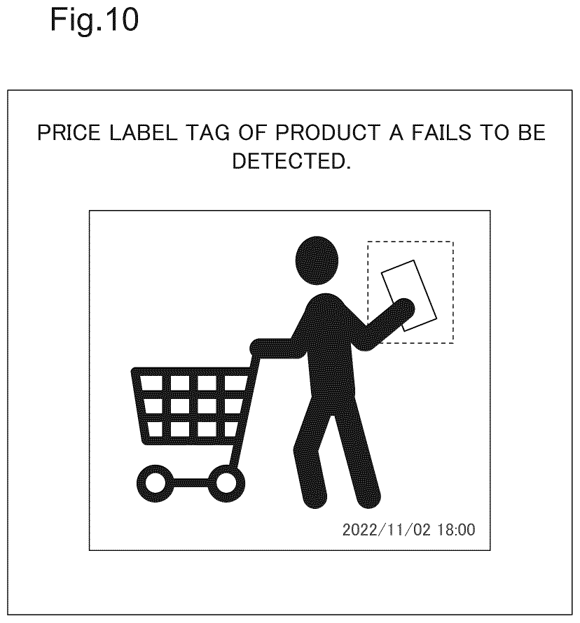

The output control unit 113 causes the terminal device of the store clerk to identify and display the product or the customer on the image captured. The output control unit 113 may cause a part where the product or the customer is identified on the image to be displayed while being surrounded to grasp the product or the customer. FIG. 10 illustrates an example output by the output control unit 113. The example of FIG. 10 shows a product that is identified and displayed on an image being captured by the security camera.

### (Flowchart)

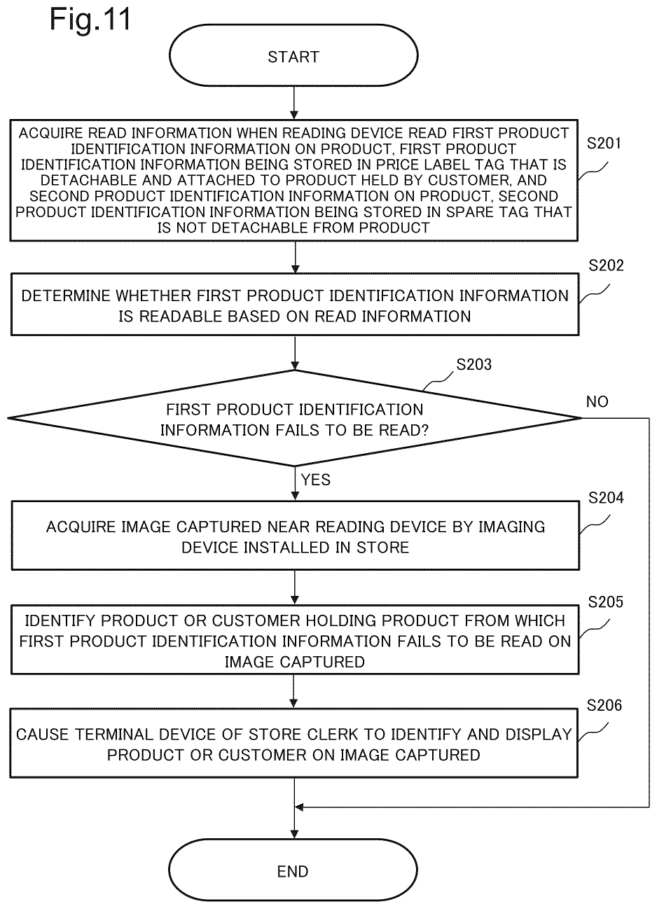

FIG. 11 is a flowchart illustrating an outline of operation of a notification device 110 according to a modification of the second example embodiment. Processing according to this flowchart may be performed based on program control performed by the processor described above.

As illustrated in FIG. 11, the acquisition unit 111 first acquires read information on the first product identification information on the product, the first product identification information being stored in the price label tag that is detachable and attached to the product held by the customer, and the second product identification information on the product, the second product identification information being stored in the spare tag that is not detachable from the product (step S201). Next, the determination unit 112 determines whether the first product identification information is readable based on the read information (step S202). When the determination unit 112 determines that the first product identification information fails to be read (S203; YES), the image acquisition unit 114 acquires an image captured near the reading device 210 by the imaging device installed in the store (step S204). In contrast, when the determination unit 112 determines that the first product identification information has been read (S203; NO), the flow is ended.

Next, the identification unit 115 identifies a product or a customer holding the product that is determined to fail to read the first product identification information on the image captured (step S205). Finally, the output control unit 113 causes the terminal device of the store clerk to identify and display the product or the customer on the image captured (step S206). Then, the notification device 110 ends the flow.

The notification device 110 in the present example embodiment causes the identification unit 115 to identify a product or a customer holding the product that is determined to fail to read the first product identification information on the image captured. Then, the output control unit 113 causes the terminal device of the store clerk to identify and display the product or the customer on the image captured. Consequently, the product or the customer can be identified on the image captured, so that the product that may be shoplifted or the customer that may shoplift can be easily grasped. In particular, when the product or the customer is identified on an image being captured by the security camera, the product or the customer can be tracked.

### Third Example Embodiment

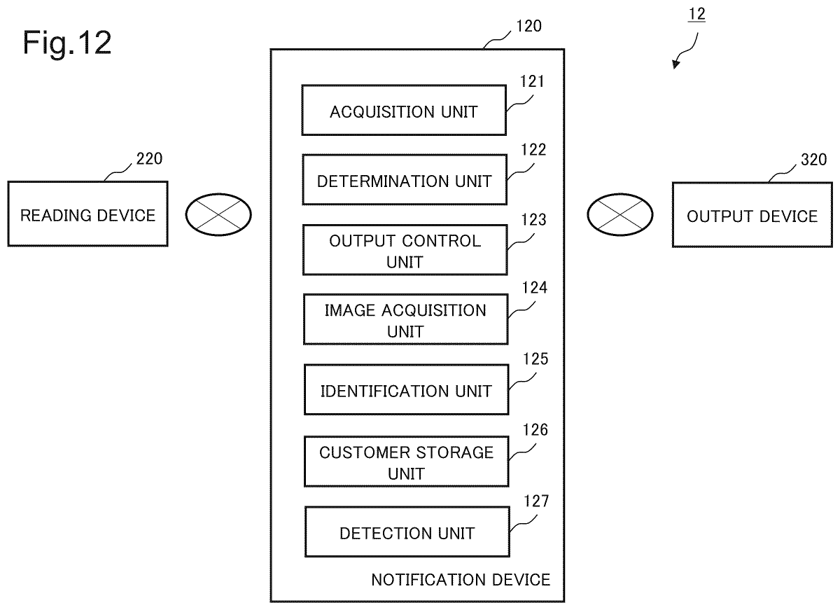

Next, a third example embodiment of the present disclosure will be described in detail with reference to the drawings. FIG. 12 is a block diagram including a notification device 120 according to the third example embodiment. A notification system 12 according to the present example embodiment includes the notification device 120 that is connected to a reading device 220 and an output device 320 through a network.

Hereinafter, duplicated contents with the above description will not be described to the extent that the description of the present example embodiment is not unclear. As in the computer device illustrated in FIG. 5, the function of each component in each example embodiment of the present disclosure can be achieved not only by hardware but also by a computer device or software based on program control.

With reference to FIG. 12, the notification device 120 includes an acquisition unit 121, a determination unit 122, an output control unit 123, an image acquisition unit 124, an identification unit 125, a customer storage unit 126, and a detection unit 127. The acquisition unit 121, the determination unit 122, the image acquisition unit 124, and the identification unit 125 are similar to associated configurations of the first example embodiment and the second example embodiment, and thus will not be described.

The customer storage unit 126 stores an image of a customer holding a product identified by the image acquisition unit 124. Specifically, the customer storage unit 126 stores an apparent feature value of the face or the like of the identified customer in the storage device 505. When storing the image of the customer, the customer storage unit 126 collates the image with an image of the customer already stored, and counts the number of times of storage. The customer storage unit 126 further stores a customer stored for a predetermined number of times or more in the storage device 505 as a customer requiring attention.

The detection unit 127 detects a visit of the customer requiring attention based on a stored image of the customer requiring attention. For example, the detection unit 127 collates an image included in a list of customers requiring attention stored in the storage device 505 with a captured image of a customer in the store, and detects a visit of the customer included in the list of the customers requiring attention. When detecting the visit of the customer requiring attention, the detection unit 127 outputs information on the visit to the output control unit 123. The detection unit 127 may output an image of a customer requiring attention and information to the output control unit 123, the information indicating a position of a store where the customer requiring attention is present.

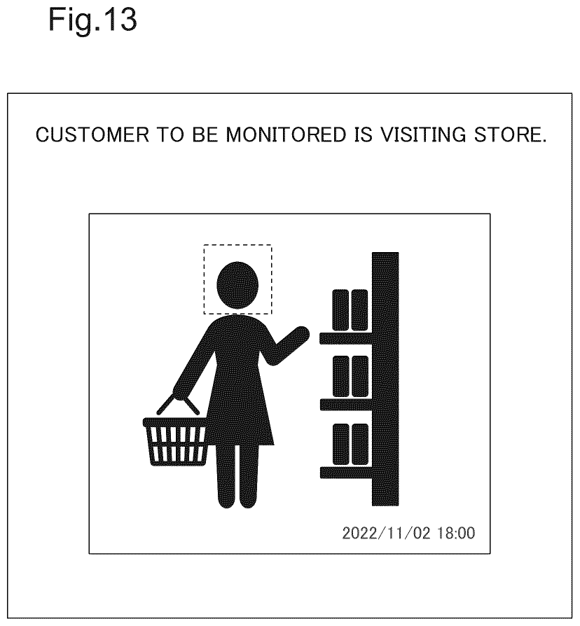

When detecting the visit of the customer requiring attention, the output control unit 123 notifies the terminal device of the store clerk of the visit of the customer requiring attention. The output control unit 123 outputs a message notifying that a customer who needs to be monitored has visited a store, for example. FIG. 13 is an example of output to the terminal device of the store clerk according to the third example embodiment. As illustrated in FIG. 13, the output control unit 123 identifies the customer requiring attention on an image being captured by the security camera. This identification enables action of the customer requiring attention to be monitored on the image of the security camera.

### (Flowchart)

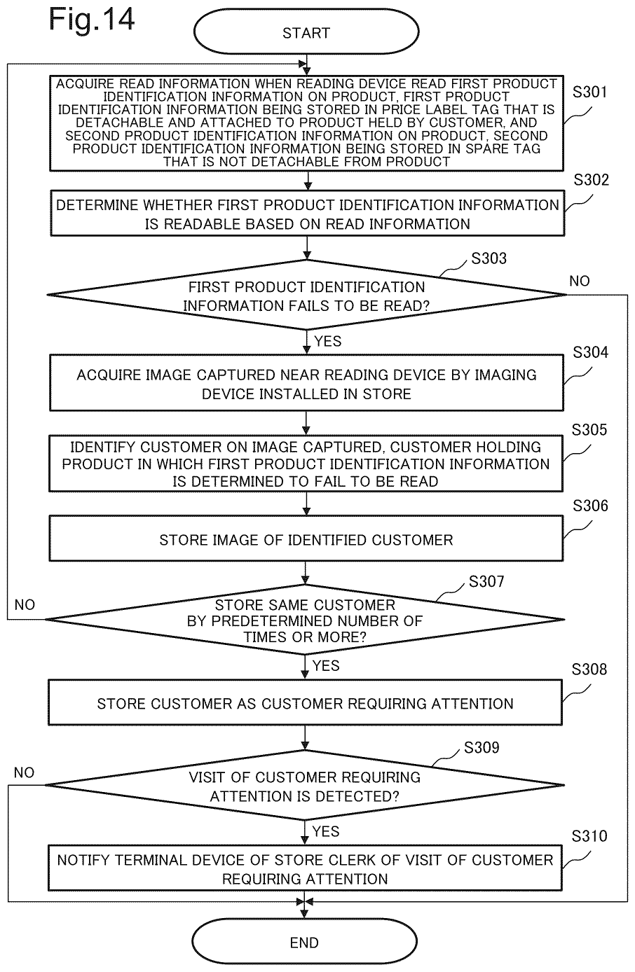

FIG. 14 is a flowchart illustrating an outline of operation of a notification device 120 according to a modification of the third example embodiment. Processing according to this flowchart may be performed based on program control performed by the processor described above.

As illustrated in FIG. 14, the acquisition unit 121 first acquires read information on the first product identification information on the product, the first product identification information being stored in the price label tag that is detachable and attached to the product held by the customer, and the second product identification information on the product, the second product identification information being stored in the spare tag that is not detachable from the product (step S301). Next, the determination unit 122 determines whether the first product identification information is readable based on the read information (step S302). When the determination unit 122 determines that the first product identification information fails to be read (S303; YES), the image acquisition unit 124 acquires an image captured near the reading device 220 by the imaging device installed in the store (step S304). In contrast, when the determination unit 112 determines that the first product identification information has been read (S303; NO), the flow is ended.

Next, the identification unit 125 identifies a customer holding a product that is determined to fail to read the first product identification information on the image captured (step S305). Subsequently, the customer storage unit 126 stores an image of the customer identified (step S306). When the customer storage unit 126 stores an image of the same customer for a predetermined number of times or more (S307; YES), the customer is stored as a customer requiring attention (step S308). In contrast, when the number of times of storing the image in the customer storage unit 126 is less than the predetermined number of times (S307; NO), the notification device 120 repeats the flow of S301 to S307. Subsequently, when the detection unit 127 detects a visit of the customer requiring attention based on the stored image of the customer requiring attention (S309; YES), the output control unit 123 notifies the terminal device of the store clerk of the visit of the customer requiring attention (step S310). In contrast, when the detection unit 127 does not detect the customer requiring attention having visited the store (step S309; NO), the flow is ended.

When the customer storage unit 126 stores an image of the same customer for a predetermined number of times or more, the customer is stored as a customer requiring attention in the present example embodiment. Then, when the detection unit 127 detects a visit of the customer requiring attention based on the stored image of the customer requiring attention, the output control unit 123 notifies the terminal device of the store clerk of the visit of the customer requiring attention. Consequently, the store clerk can be notified of the visit of the customer requiring attention who has been detected several times while holding a product from which a price label tag has been removed.

While the present disclosure has been particularly shown and described with reference to each of the example embodiments, the present disclosure is not limited to the example embodiments. Each configuration and details of the present disclosure may include an example embodiment to which various changes are applied, the various changes being able to be grasped by those skilled in the art within the scope of the present disclosure. The present disclosure may include an example embodiment in which the matters described in the present specification are appropriately combined or replaced as necessary. For example, the matters described using a specific example embodiment can be applied to another example embodiment as long as no contradiction occurs. For example, although the plurality of operations is described in order in the form of a flowchart, the order of description does not limit the order in which the plurality of operations is performed. Thus, when each example embodiment is implemented, the order of the plurality of operations can be changed within a range that does not interfere with the content.

Some or all of the above example embodiments can also be described as the following supplementary notes. However, some or all of the above example embodiments are not limited to the following.

### (Supplementary Note 1)

A notification device including:
acquisition means for acquiring read information when a reading device reads first product identification information on a product, the first product identification information being stored in a price label tag that is detachable and attached to the product held by a customer, and second product identification information on the product, the second product identification information being stored in a spare tag that is not detachable from the product;
determination means for determining whether the first product identification information is readable based on the read information; and output control means for notifying determination when the first product identification information is determined to fail to be read.

### (Supplementary Note 2)

The notification device described in the supplementary note 1, in which the reading device is installed at a place where the customer passes through.

### (Supplementary Note 3)

The notification device described in the supplementary note 1 or 2, in which the acquisition means acquires the read information including received signal strength from a first RFID included in the price label tag and a second RFID included in the spare tag, or a number of times of reading of the first product identification information and the second product identification information per unit time.

### (Supplementary Note 4)

The notification device described in the supplementary note 3, in which the determination means determines that the first product identification information fails to be read when the received signal strength from the first RFID is smaller than a preset threshold, or when the received signal strength from the first RFID is smaller than the received signal strength from the second RFID by a predetermined value or more.

### (Supplementary Note 5)

The notification device described in the supplementary note 3, in which the determination means determines that the first product identification information fails to be read when the number of times of reading the first product identification information is smaller than a preset threshold or when the number of times of reading the first product identification information is smaller than the number of times of reading the second product identification information by a predetermined number of times or more.

### (Supplementary Note 6)

The notification device described in any one of the supplementary notes 1 to 5, in which
the acquisition means acquires the second product identification information read when the first product identification information is determined to fail to be read, and
the output control means outputs product information associated with the second product identification information.

### (Supplementary Note 7)

The notification device described in any one of the supplementary notes 1 to 6, in which
the acquisition means acquires read information on first product identification information on the product before a predetermined time when the first product identification information is determined to fail to be read,
the determination means determines whether the first product identification information has been read before the predetermined time, and
the output control means issues a notification when it is determined that the first product identification information before the predetermined time has been read.

### (Supplementary Note 8)

The notification device described in any one of the supplementary notes 1 to 7, further including:
image acquisition means for acquiring an image captured near a reading device by an imaging device installed in a store when the first product identification information fails to be read; and
identification means for identifying a product or a customer holding the product that is determined to fail to read the first product identification information on the image captured that is acquired in which the output control means causes a terminal device of a store clerk to identify and display the product or the customer on the image captured.

### (Supplementary Note 9)

The notification device described in the supplementary note 8, further including: customer storage means for storing a photographed image of a customer holding the product identified.

### (Supplementary Note 10)

The notification device described in the supplementary note 9, in which when the customer storage means stores one customer for a predetermined number of times or more, the customer storage means stores the one customer as a customer requiring attention.

### (Supplementary Note 11)

The notification device described in the supplementary note 10,further including:
detection means for detecting a customer requiring attention who has visited a store based on the stored image of the customer requiring attention,
in which the output control means notifies a terminal device of a store clerk of a visit of a customer requiring attention when the customer requiring attention is detected.

### (Supplementary Note 12)

A notification system including: products sold in a store; and the notification device described in any one of the supplementary notes 1 to 11,
the products each including: a price label tag that is detachable and stores first product identification information; a spare tag that is not detachable and stores second product identification information; and lighting means,
in which the output control means turns on the lighting means when the first product identification information is determined to fail to be read.

### (Supplementary Note 13)

A notification system including: a reading device; and the notification device described in any one of the supplementary notes 1 to 11,
in which the reading device is installed at least at a place of any one of a place near a fitting room and a settlement gate, and reads first product identification information on a product, the first product identification information being stored in a price label tag that is detachable and attached to the product, and second product identification information on the product, the second product identification information being stored in a spare tag that is not detachable from the product.

### (Supplementary Note 14)

The notification system described in the supplementary note 13, in which
the reading device is installed at the settlement gate, and
the output control means outputs an instruction to a terminal device installed at the settlement gate for a guide to another place where another reading device is installed when the first product identification information is determined to fail to be read by the reading device.

### (Supplementary Note 15)

A notification method including:
acquiring read information when a reading device reads first product identification information on a product, the first product identification information being stored in a price label tag that is detachable and attached to the product held by a customer, and second product identification information on the product, the second product identification information being stored in a spare tag that is not detachable from the product;
determining whether the first product identification information is readable based on the read information; and
notifying determination when the first product identification information is determined to fail to be read.

### (Supplementary Note 16)

A non-transitory recording medium storing a program that causes a computer to perform the steps of:
acquiring read information when a reading device reads first product identification information on a product, the first product identification information being stored in a price label tag that is detachable and attached to the product held by a customer, and second product identification information on the product, the second product identification information being stored in a spare tag that is not detachable from the product;
determining whether the first product identification information is readable based on the read information; and
notifying determination when the first product identification information is determined to fail to be read,
the non-transitory recording medium being readable by the computer.

### REFERENCE SIGNS LIST

10, 11, 12 notification system
100, 110, 120 notification device
101, 111, 121 acquisition unit
102, 112, 122 determination unit
103, 113, 123 output control unit
114, 124 image acquisition unit
115, 125 identification unit
126 customer storage unit
127 detection unit
200, 210, 220 reading device
300, 310, 320 output device
500 computer device
501 CPU
502 ROM
503 RAM
504 program
505 storage device
506 recording medium
507 drive device
508 communication interface
509 input/output interface
510 bus

What is claimed is:

1. A notification device comprising:
at least one memory storing instructions; and
at least one processor configured to execute the instructions to:
acquire a read information when a reading device reads first product identification information on a product, the first product identification information being stored in a price label tag that is detachable and attached to the product held by a customer, and second product identification information on the product, the second product identification information being stored in a spare tag that is not detachable from the product;
determine whether the first product identification information is readable based on the read information; and
notify determination when the first product identification information is determined to fail to be read.

2. The notification device according to claim 1, wherein the reading device is installed at a place where the customer passes through.

3. The notification device according to claim 1,
wherein the at least one processor is further configured to execute the instructions to:
acquire the read information including received signal strength from a first RFID included in the price label tag and a second RFID included in the spare tag, or a number of times of reading of the first product identification information and the second product identification information per unit time.

4. The notification device according to claim 3,
wherein the at least one processor is further configured to execute the instructions to:
determine that the first product identification information fails to be read when the received signal strength from the first RFID is smaller than a preset threshold, or when the received signal strength from the first RFID is smaller than the received signal strength from the second RFID by a predetermined value or more.

5. The notification device according to claim 3,
wherein the at least one processor is further configured to execute the instructions to:
determine that the first product identification information fails to be read when the number of times of reading the first product identification information is smaller than a preset threshold or when the number of times of reading the first product identification information is smaller than the number of times of reading the second product identification information by a predetermined number of times or more.

6. The notification device according to claim 1,
wherein the at least one processor is further configured to execute the instructions to:
acquire the second product identification information read when the first product identification information is determined to fail to be read, and
output product information associated with the second product identification information.

7. The notification device according to claim 1,
wherein the at least one processor is further configured to execute the instructions to:
acquire read information on first product identification information on the product before a predetermined time when the first product identification information is determined to fail to be read,
determine whether the first product identification information has been read before the predetermined time, and
notify when it is determined that the first product identification information before the predetermined time has been read.

8. The notification device according to claim 1,
wherein the at least one processor is further configured to execute the instructions to:
acquire an image captured near a reading device by an imaging device installed in a store when the first product identification information fails to be read;
identify a product or a customer holding the product that is determined to fail to read the first product identification information on the image captured that is acquired;
identify the product or the customer on the image captured; and
display the product or the customer on the image captured.

9. The notification device according to claim 8,
wherein the at least one processor is further configured to execute the instructions to:
store a photographed image of a customer holding the product identified in a storage device.

10. The notification device according to claim 9,
wherein the at least one processor is further configured to execute the instructions to:
store the photographed image of customer as a customer requiring attention when the customer is stored more than a predetermined number of times in the storage device.

11. The notification device according to claim 10,
wherein the at least one processor is further configured to execute the instructions to:
detect a customer requiring attention who has visited a store based on the stored image of the customer requiring attention; and
notify a terminal device of a store clerk of a visit of the customer requiring attention when the customer requiring attention is detected.

12. (Canceled)

13. A notification system comprising:
the notification device according to claim 1; and
a reading device that is installed at least at a place of any one of a place near a fitting room and a settlement gate, and reads first product identification information on a product, the first product identification information being stored in a price label tag that is detachable and attached to the product, and second product identification information on the product, the second product identification information being stored in a spare tag that is not detachable from the product.

14. The notification system according to claim 13, wherein
the reading device is installed at the settlement gate, and
the at least one processor of the notification device is further configured to execute the instructions to:
output an instruction to a terminal device installed at the settlement gate for a guide to another place where another reading device is installed when the first product identification information is determined to fail to be read by the reading device.

15. A notification method comprising:
by a computer,
acquiring read information when a reading device reads first product identification information on a product, the first product identification information being stored in a price label tag that is detachable and attached to the product held by a customer, and second product identification information on the product, the second product identification information being stored in a spare tag that is not detachable from the product;
determining whether the first product identification information is readable based on the read information; and
notifying determination when the first product identification information is determined to fail to be read.

16. A non-transitory recording medium storing a program that causes a computer to perform the steps of:
acquiring read information when a reading device reads first product identification information on a product, the first product identification information being stored in a price label tag that is detachable and attached to the product held by a customer, and second product identification information on the product, the second product identification information being stored in a spare tag that is not detachable from the product;
determining whether the first product identification information is readable based on the read information; and
notifying determination when the first product identification information is determined to fail to be read, the non-transitory recording medium being readable by the computer.

17. A notification system comprising:
a price label tag that is detachable and stores first product identification information;
a spare tag that is not detachable and stores second product identification information;
a lighting device; and
the notification device according to claim 1,
wherein the at least one processor of the notification device is further configured to execute the instructions to,
turn on the lighting device when the first product identification information is determined to fail to be read.
